(19) United States
(12) Patent Application Publication
(10) Pub. No.: US 2019/0278124 A1
(43) Pub. Date: Sep. 12, 2019

(54) LIQUID CRYSTAL DISPLAY PANEL AND MOBILE TERMINAL

(71) Applicant: Wuhan China Star Optoelectronics Technology Co., Ltd., Wuhan (CN)

(72) Inventor: Zongxian KANG, Wuhan (CN)

(21) Appl. No.: 16/244,261

(22) Filed: Jan. 10, 2019

Related U.S. Application Data
(63) Continuation of application No. PCT/CN2018/119289, filed on Dec. 5, 2018.

(30) Foreign Application Priority Data
Mar. 7, 2018 (CN) 201810186787.3

(51) Int. Cl. G02F 1/1345; G02F 1/13357

(52) U.S. Cl. CPC G02F 1/13452; G02F 1/1336

(57) ABSTRACT

Disclosed is a liquid crystal display panel, wherein one surface of the liquid crystal display panel includes: an effective display area, a first non-display area which is ring-shaped and is disposed around an outer circumference of the effective display area and a second non-display area which is block-shaped and is connected to the first non-display area, wherein: an area where the effective display area and the first non-display area are located correspond to an area where the liquid crystal display panel possesses a backlight module, and an area where the second non-display area is correspondingly arranged with a connecting member, and the connecting member is a block structure that connects the backlight module of the liquid crystal display panel to an external control module. Further disclosed is a mobile terminal.

### CROSS-REFERENCE TO RELATED APPLICATION

This application is a continuing application of PCT Patent Application No. PCT/CN2018/119289 entitled “Liquid crystal display panel and mobile terminal”, filed on, Dec. 5, 2018, which claims priority to Chinese Patent Application No. 201810186787.3, filed on Mar. 7, 2018, both of which are hereby incorporated in its entireties by reference.

### FIELD OF THE INVENTION

The present invention relates to a display technology field, and more particularly to a liquid crystal display panel and a mobile terminal.

### BACKGROUND OF THE INVENTION

With the increasing display capabilities of mobile devices such as mobile phones, consumers are increasingly demanding the aesthetics of mobile terminals. In the prior art, the improvement of the display screen occupation ratio of the mobile terminal can achieve a better visual impact, and has become a trend pursued by mobile phone manufacturers and consumers in the market. However, due to the connection design problem of the inherent line of the LCD display panel, the occupation ratio of the LCD display screen (the area in which the effective display area occupies the terminal's own area) cannot be further effectively improved.

For instance, as shown in FIG. 3, the composition of the screen occupation ratio on the side of the existing LCD display panel is composed of the following three parts: an effective display area 91, a BM area 92 disposed around the periphery of the effective display area 91, and a Pad area 93 connected to the top of the BM area 92 as shown in figure, and the Pad area 93 is disposed with an FPC flexible circuit board 94 and an IC integrated circuit 95. Only the effective display area 91 on the display panel is configured for display, while the BM area 92 around the periphery is also necessary. Therefore, a new structural design is needed to increase the occupation ratio of LCD display screen.

### SUMMARY OF THE INVENTION

The technical problem to be solved by the present invention is to provide a liquid crystal display panel and a mobile terminal, which can optimize the area of the Pad area of the display panel and the connection with the control panel of the mobile terminal to improve the assembly efficiency of the module; the display screen occupation ratio of the liquid crystal display panel and the mobile terminal is further improved.

For solving the aforesaid technical issue, the present invention provides a liquid crystal display panel, wherein one surface of the liquid crystal display panel includes: an effective display area, a first non-display area which is ring-shaped and is disposed around an outer circumference of the effective display area and a second non-display area which is block-shaped and is connected to the first non-display area, wherein: an area where the effective display area and the first non-display area are located correspond to an area where the liquid crystal display panel possesses a backlight module, and an area where the second non-display area is located corresponds to an area where a connecting member is arranged, and the connecting member is a block structure that connects the backlight module of the liquid crystal display panel to an external control module.

The block connecting member possesses a width dimension less than or equal to 1.5 mm.

A length dimension of the connecting member is same as a width dimension of the first non-display area.

The external control module is a control board that can control the backlight module.

The first non-display area is a square ring-shaped structure with a width value set to a certain value.

The width value is less than or equal to 0.8 mm.

For solving the aforesaid technical issue, the present invention further discloses a liquid crystal display panel, wherein one surface of the liquid crystal display panel includes: an effective display area, a first non-display area which is ring-shaped and is disposed around an outer circumference of the effective display area and a second non-display area which is block-shaped and is connected to the first non-display area, wherein: an area where the effective display area and the first non-display area are located correspond to an area where the liquid crystal display panel possesses a backlight module, and an area where the second non-display area is located corresponds to an area where a connecting member is arranged, and the connecting member is a block structure that connects the backlight module of the liquid crystal display panel to an external control module; the first non-display area is a square ring-shaped structure with a width value set to a certain value, and the connecting member possesses a width dimension less than or equal to 1.5 mm.

A length dimension of the connecting member is same as a width dimension of the first non-display area.

The external control module is a control board that can control the backlight module.

The width value is less than or equal to 0.8 mm.

For solving the aforesaid technical issue, the present invention further discloses a mobile terminal, including a liquid crystal display panel and a control board, wherein one surface of the liquid crystal display panel includes: an effective display area, a first non-display area which is ring-shaped and is disposed around an outer circumference of the effective display area and a second non-display area which is block-shaped and is connected to the first non-display area, wherein: an area where the effective display area and the first non-display area are located correspond to an area where the liquid crystal display panel possesses a backlight module, and an area where the second non-display area is located is correspondingly arranged with a connecting member, and the connecting member is a block structure that connects the backlight module of the liquid crystal display panel to the control board.

A length dimension of the second non-display area is same as a width dimension of the first non-display area.

The second non-display area possesses a width dimension less than or equal to 1.5 mm.

The first non-display area is a square ring-shaped structure with a width value set to a certain value.

The width value is set to be less than or equal to 0.8 mm.

The implementation of the liquid crystal display panel and the mobile terminal provided by the present invention possesses the following benefits: an area where the effective display area and the first non-display area are located correspond to an area where the liquid crystal display panel possesses a backlight module, and an area where the second non-display area is located corresponds to an area where a connecting member is arranged, and the connecting member is a block structure that connects the backlight module of the liquid crystal display panel to an external control module to optimize the area of the Pad area of the display panel and the connection with the control panel of the mobile terminal to improve the assembly efficiency of the module; the display screen occupation ratio of the liquid crystal display panel and the mobile terminal is further improved.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a structural view diagram of a screen occupation ratio of a liquid crystal display panel from a first view angle according to an embodiment of the present invention.

FIG. 2 is a structural view diagram of a screen occupation ratio of a liquid crystal display panel from a second view angle according to an embodiment of the present invention.

FIG. 3 is a structural view diagram of a screen occupation ratio of a liquid crystal display panel according to an embodiment of the prior art.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

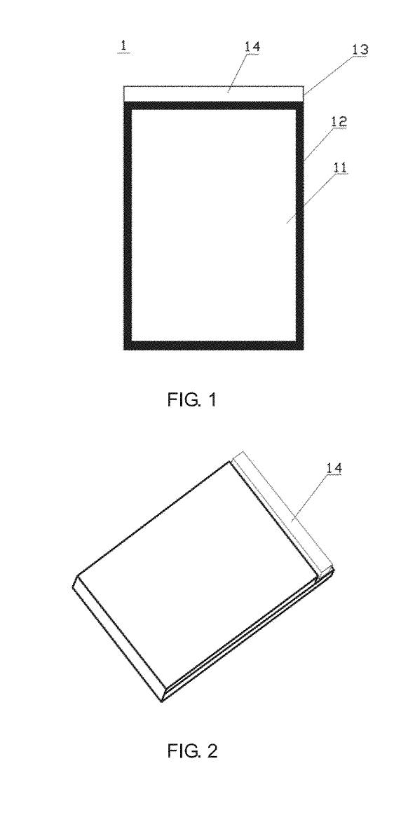

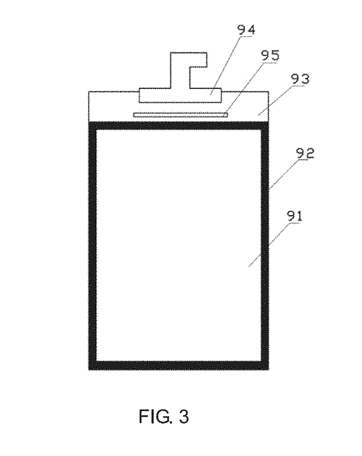

As shown in FIG. 1 and FIG. 2, the liquid crystal display panel according to the first embodiment of the present invention is presented.

The liquid crystal display panel in this embodiment can be applied to mobile terminals, such as mobile phones, cameras and tablets. The mobile terminal includes at least a liquid crystal display panel 1 and an external control module for controlling the liquid crystal display panel 1, which is the control board of the mobile terminal in this embodiment. The structure of the liquid crystal display panel and the connection to the control main board will be described in detail below.

The liquid crystal display panel 1 in this embodiment has a substantially flat plate shape. One surface with display function thereof includes: an effective display area 11 located in the middle of the liquid crystal display panel 1, a first non-display area 12 which is ring-shaped and is disposed around an outer circumference of the effective display area 11 and a second non-display area 13 which is block-shaped and is connected to the first non-display area 12.

When implemented, an area where the effective display area 11 and the first non-display area 12 are located correspond to an area where the liquid crystal display panel possesses a backlight module. Further, the first non-display area 12 is a ring-shaped black matrix (BM) area and is disposed around the outer circumference of the effective display area 11, and the first non-display area 12 is a frame structure.

Preferably, the first non-display area 12 is a square ring-shaped structure with a width value set to a certain value. The width value is less than or equal to 0.8 mm. This width value is the width limit value under the current process conditions.

Further, an area where the second non-display area 13 is located is a block area connected to a top of the first non-display area 12, which corresponds to a Pad area of the display panel. A connecting member correspondingly disposed in this area connects the backlight module in the area where the effective display area 11 and the first non-display area 12 are located to a control board.

In this embodiment, a connecting member 14 which is a block shape is disposed in the area where the second non-display area 13 is located. Meanwhile, the block-shaped connecting member 14 connects the backlight module of the liquid crystal display panel to the control board.

Further, since the structural design of the connecting block is smaller and is more compact than that of the FPC flexible circuit board and the structure of the IC integrated circuit in the prior art. Namely, eliminating the structural design of the FPC flexible circuit board and the IC integrated circuit can further reduce the area occupied by the second non-display area 13, that is, reducing the area of the Pad area on the surface of the entire panel. Thus, the area occupied by the entire area of the first non-display area 12 and the second non-display area 13 is made smaller, and the screen occupation ratio of the effective display area 11 of the liquid crystal display panel is increased.

Preferably, a length dimension of the connecting member 14 is same as a width dimension of the first non-display area. The second non-display area 13 replaces the connection structure of the FPC flexible circuit board and the IC integrated circuit by using the block-shaped connecting member. The width dimension of the block-shaped connecting member can be less than or equal to 1.5 mm. Accordingly, the width dimension of the second non-display area 13, i.e. the Pad area is less than or equal to 1.5 mm, for reducing the area occupied by the second non-display region 13 over the entire panel surface.

Specifically, the circuit of the original IC integrated circuit can still be retained, and the IC integrated chip is directly integrated on the control board of the mobile terminal, thereby simplifying the process flow and shortening the process flow of the module segment; it is conducive to the integration of the entire mobile terminal system and to improve the quality of the product.

Besides, in the second non-display area 13, the connection structure of the FPC flexible circuit board and the IC integrated circuit is replaced by using a block-shaped connecting member, so that the screen occupation ratio of the effective display area 11 of the display panel is increased by 5% to 8% (it is related to the size of the effective display area 11, the smaller the size of the effective display area 11, the more the screen occupation ratio is increased), therefore possessing a better visual impact. Moreover, the increase of the screen occupation ratio of the effective display area 11 of the display panel is also more beneficial for the increase of the screen occupation ratio of the mobile terminal itself (the ratio of the area of the display area of the mobile terminal to the area of the cover plate itself), which can be increased about 10%.

The mobile terminal disclosed in the embodiment of the present invention, such as a mobile phone, a camera and a tablet computer, utilizes the aforesaid liquid crystal display panel. The specific implementation of the mobile terminal is the same as that of the foregoing liquid crystal display panel, and details are not repeated herein.

The implementation of the liquid crystal display panel and the mobile terminal provided by the present invention possesses the following benefits: an area where the effective display area and the first non-display area are located correspond to an area where the liquid crystal display panel possesses a backlight module, and an area where the second non-display area is located corresponds to an area where a connecting member is arranged, and the connecting member is a block structure that connects the backlight module of the liquid crystal display panel to an external control module to optimize the area of the Pad area of the display panel and the connection with the control panel of the mobile terminal to improve the assembly efficiency of the module; the display screen occupation ratio of the liquid crystal display panel and the mobile terminal is further improved.

What is claimed is:

1. A liquid crystal display panel, wherein one surface of the liquid crystal display panel includes: an effective display area, a first non-display area which is ring-shaped and is disposed around an outer circumference of the effective display area and a second non-display area which is block-shaped and is connected to the first non-display area, wherein:
an area where the effective display area and the first non-display area are located correspond to an area where the liquid crystal display panel possesses a backlight module, and an area where the second non-display area is located corresponds to an area where a connecting member is arranged, and the connecting member is a block structure that connects the backlight module of the liquid crystal display panel to an external control module.

2. The liquid crystal display panel according to claim 1, wherein the connecting member possesses a width dimension less than or equal to 1.5 mm.

3. The liquid crystal display panel according to claim 1, wherein a length dimension of the connecting member is same as a width dimension of the first non-display area.

4. The liquid crystal display panel according to claim 1, wherein the external control module is a control board that can control the backlight module.

5. The liquid crystal display panel according to claim 1, wherein the first non-display area is a square ring-shaped structure with a width value set to a certain value.

6. The liquid crystal display panel according to claim 5, wherein the width value is less than or equal to 0.8 mm.

7. A liquid crystal display panel, wherein one surface of the liquid crystal display panel includes: an effective display area, a first non-display area which is ring-shaped and is disposed around an outer circumference of the effective display area and a second non-display area which is block-shaped and is connected to the first non-display area, wherein:
an area where the effective display area and the first non-display area are located correspond to an area where the liquid crystal display panel possesses a backlight module, and an area where the second non-display area is located corresponds to an area where a connecting member is arranged, and the connecting member is a block structure that connects the backlight module of the liquid crystal display panel to an external control module;
wherein the first non-display area is a square ring-shaped structure with a width value set to a certain value, and the connecting member possesses a width dimension less than or equal to 1.5 mm.

8. The liquid crystal display panel according to claim 7, wherein a length dimension of the connecting member is same as a width dimension of the first non-display area.

9. The liquid crystal display panel according to claim 7, wherein the external control module is a control board that can control the backlight module.

10. The liquid crystal display panel according to claim 7, wherein the width value is less than or equal to 0.8 mm.

11. A mobile terminal, including a liquid crystal display panel and a control board, wherein one surface of the liquid crystal display panel includes: an effective display area, a first non-display area which is ring-shaped and is disposed around an outer circumference of the effective display area and a second non-display area which is block-shaped and is connected to the first non-display area, wherein:
an area where the effective display area and the first non-display area are located correspond to an area where the liquid crystal display panel possesses a backlight module, and an area where the second non-display area is located is correspondingly arranged with a connecting member, and the connecting member is a block structure that connects the backlight module of the liquid crystal display panel to the control board.

12. The mobile terminal according to claim 11, wherein a length dimension of the second non-display area is same as a width dimension of the first non-display area.

13. The mobile terminal according to claim 12, wherein the second non-display area possesses a width dimension less than or equal to 1.5 mm.

14. The mobile terminal according to claim 11, wherein the first non-display area is a square ring-shaped structure with a width value set to a certain value.

15. The mobile terminal according to claim 14, wherein the width value is less than or equal to 0.8 mm.
